(19) United States
(12) Patent Application Publication
(10) Pub. No.: US 2012/0080894 A1
(43) Pub. Date: Apr. 5, 2012

(54) Doggie Scoop

(76) Inventor: Marilyn M. Williamson, Brooklyn, NY (US)

(21) Appl. No.: 13/075,126

(22) Filed: Mar. 29, 2011

Related U.S. Application Data
(60) Provisional application No. 61/376,931, filed on Aug. 25, 2010.

(51) Int. Cl. A01K 29/00; B65D 33/16

(52) U.S. Cl. 294/1.4; 294/1.3; 383/71

(57) ABSTRACT

The Doggie Scoop, included with a disposable plastic bag, is a device for the efficient and sanitary collection and disposal of canine fecal matter (dog poop). Before using the Doggie Scoop, insert a disposable plastic bag into Scoop, then, when a dog gets ready to poop, slide the lock on the handle of the Scoop forward with your thumb to open the Scoop (which will be opened horizontally), then slide the extension of the Scoop under the dog to catch the poop. The extension of the Scoop should lie flat against the ground since dogs usually squat close to the ground when they poop. The wheels on the Doggie Scoop help in sliding the Scoop under the dog, and since the wheels can rotate 360 degrees, the Scoop can be moved in any direction to accommodate any movement of the dog. When the dog is finished, slide the Scoop out from under the dog, squeeze the handle on the Scoop to close the Scoop, and with your thumb, slide the lock on the handle of the Scoop backward to lock the Scoop and keep it closed. The poop that collects on the extension will now drop into the storage box. Grasp the pull cords on the enclosed plastic bag to remove the bag with its contents, then dispose of the plastic bag in a garbage can. The Doggie Scoop enables a person to collect the dog poop before it touches the ground and to dispose of the poop in a sanitary manner without having to bend down to pick up the poop or to touch the stuff.

### CROSS-REFERENCE TO RELATED APPLICATIONS

Reference is made to Provisional Application No. 61/376,931, filed Aug. 25, 2010. The Provisional Application for the Doggie Scoop precedes this Non-Provisional Application. See the attached Application Data Sheet.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND AND PRIOR ART

Canine fecal matter (dog poop) that is left on the ground is unsightly, it creates unhygienic conditions and an unsanitary environment, and, if people come in contact with the poop, it can cause serious human illnesses. When people come in contact with dog poop, the bacteria in the poop can cause cramps, diarrhea, intestinal illnesses and kidney disorders. Bacteria from the run-off from dog poop can also contaminate rivers, lakes, and other water systems, and, since dog poop is not a fertilizer, it can discolor and damage lawns. Dog poop left on the ground is also a public nuisance and makes it difficult to walk on the ground since you have to constantly watch where you step.

In an effort to avoid the hazards of dog poop left on the ground, the governments of many cities have passed legislation requiring dog owners and dog handlers to pick up after their pets or be subject to hefty fines. In compliance with this, New York City passed its “Pooper Scooper” law in 1978. Most people abide by the law, but many do not, and this is a problem. I perceive that one of the main reasons that people so not pick up after their pets is that they do not have available to them the correct device to use in picking up the dog poop.

Most of the people who pick up after their pets, pick up the poop with their hands in a plastic bag. Picking up dog poop with your hand in a plastic bag is, in itself, gross; but picking up dog poop with your hand in a plastic bag when the dog releases wet or messy poop, or on a rainy day, can be especially disgusting. This is perhaps why, in these circumstances, people do not pick up after their pets.

Also, the reason why most people do not use any sort of implement or device to catch the poop when a dog is about to poop is because there is no device on the market that enables a person to pick up dog poop in a sanitary and efficient manner.

Observing this situation, I developed the idea of the Doggie Scoop. With the Doggie Scoop, people can collect the poop before it touches the ground and dispose of it in a sanitary and efficient manner without having to bend down to pick up the poop or to touch the stuff.

A search of the prior art indicates devices for collecting and picking up dog poop that are deficient in many aspects: some are impractical, others are poorly designed and inefficient, and still others are cumbersome and difficult to use. The following is a list of some prior art that appears relevant:

| Pat. No. | Issue Date | Patentee |
|---|---|---|
| 3,740,086 | Jun. 19 1973 | Rossitto |
| 4,135,750 | Jan. 23 1979 | Rosin |
| 4,966,400 | Oct. 30 1990 | Hull |
| 6,113,166 | Sep. 05 2000 | Wynn |
| 3,937,509 | Feb. 10 1976 | Hufnagel |
| 6,386,606 | May 14 2002 | Marshall |
| 7,267,381 | Sep. 11 2007 | Cafferty |
| 6,164,710 | Dec. 26 2000 | Shibuya |
| 7,744,136 | Jun. 29 2010 | Waltz |
| 5,203,598 | Apr. 20 1993 | Lindlbauer |
| 3,744,453 | Jul. 10 1973 | Deitch |

U.S. Pat. No. 3,740,086 to Rossitto indicates a device whereby the dog poop is “picked up by pressing an open end of the container against the excreta whereby the excreta engages with the wall and rib of the container cavity.” This is impractical as the poop will get stuck in the container and will have to be removed. Additionally, the device does not collect the poop before it touches the ground.

In U.S. Pat. No. 4,135,750 to Rosin, the design is totally impractical—a rubber band has to be used to secure the members. What will happen when the rubber band breaks?

Another impractical device is U.S. Pat. No. 4,966,400 to Hull. The device is operated by “pushing the apparatus over the animal waste or debris.” How practical is that? The device will become clogged with the dog poop.

Still another impractical device is U.S. Pat. No. 6,113,166 to Wynn. Again, this device does not collect the poop before it touches the ground. Instead, a handle is pressed downward to move an attached panel that hits the poop into an attached receptacle. With this device, most of the poop will get stuck on the panel before any of it can be propelled into the collection receptacle.

Other devices are poorly designed and inefficient, including U.S. Pat. No. 3,937,509 to Hufnagel. The device is circular in design. With this design, you will not be able to properly fit the device, a cylinder shaped container, under a dog; the dog will step on the device, and then the dog will probably be startled and probably jump, causing other problems. Also, the handle on the device is not adjustable so you will have to bend down to try to get the device under the dog.

Another poorly designed device is U.S. Pat. No. 6,386,606 to Marshall. This device is also circular in design. You will not be able to properly fit the device under a dog. The dog will step on the device and into the poop. Also, the handle does not bend so that you will have to bend down to try to fit the device under the dog.

U.S. Pat. No. 7,267,381 to Cafferty indicates a device that is lightweight and compact. However, the device is poorly designed; it is circular. A dog will probably step on the device and into the poop when it is being used.

U.S. Pat. No. 6,164,710 to Shibuya indicates a device that is cumbersome and difficult to use. The device will not fit comfortably under a dog while the dog is pooping. Dogs usually squat close to the ground when they poop. This device will not fit under the dog when the dog squats. Also, the device has a trigger to open a top cover and another trigger to open a bottom cover. The device could easily malfunction and the poop will fall out of the device.

U.S. Pat. No. 7,744,136 to Waltz is cumbersome and complicated. The device includes a set of claws which seem unnecessary and don't serve any practical purpose.

Lindlbauer's device, U.S. Pat. No. 5,203,598, is cumbersome and difficult to use is. The device does not show where the poop will be collected and it includes a “v” shaped support frame which seems unnecessary as the device will not be able to fit under the dog when the dog is pooping.

Deitch's device, U.S. Pat. No. 3,744,453, is also cumbersome in that it will not comfortably fit under a dog when the dog is pooping. The dog will step on the device and into the poop.

### BRIEF SUMMARY OF THE INVENTION

The basic idea of the Doggie Scoop is to catch the dog poop before it touches the ground and to dispose of the poop in a disposable plastic bag without having to bend down and pick up the poop and without having to touch the stuff.

The Doggie Scoop works in this manner: Before using the Scoop, insert a disposable plastic bag into the Scoop, then, when a dog gets ready to poop, slide the lock on the handle of the Scoop forward with your thumb to open the Scoop. Slide the extension of the Doggie Scoop (which will now be opened horizontally) under the dog to catch the poop. The extension of the Scoop should be flat against the ground and under the dog because dogs usually squat close to the ground when they poop. The wheels on the Doggie Scoop help in sliding the Scoop, and since the wheels can rotate 360 degrees, the Scoop can be moved in any direction to accommodate any movement of the dog. When the dog is finished, slide the Scoop out from under the dog, squeeze moveable lower portion of the handle to close the Scoop, and with your thumb, slide the lock on the handle of the Scoop backward to lock the Scoop and keep it closed. The poop that collects on the extension will now drop into the storage box. Grasp the pull cords on the enclosed plastic bag to remove the bag with its contents, then dispose of the plastic bag in a garbage can.

### BRIEF DESCRIPTION OF THE SEVERAL VIEWS OF THE DRAWINGS

FIG. 1 is a view of the opened and extended Doggie Scoop

FIG. 2 is a side view of the closed Doggie Scoop

FIG. 3 is a front and side view of the disposable plastic bag

FIG. 4 is a front view of the closed Doggie Scoop

FIG. 5 is a rear view of the closed Doggie Scoop

### DETAILED DESCRIPTION OF THE INVENTION

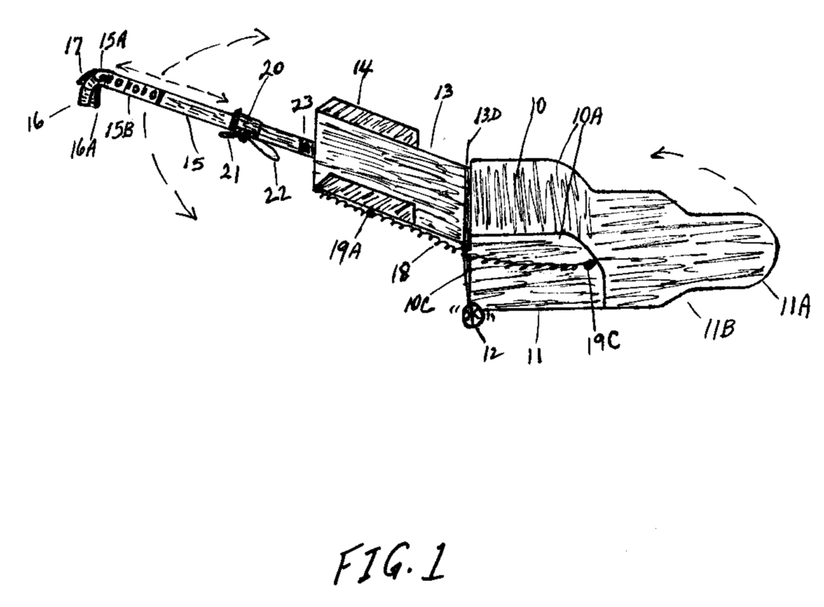

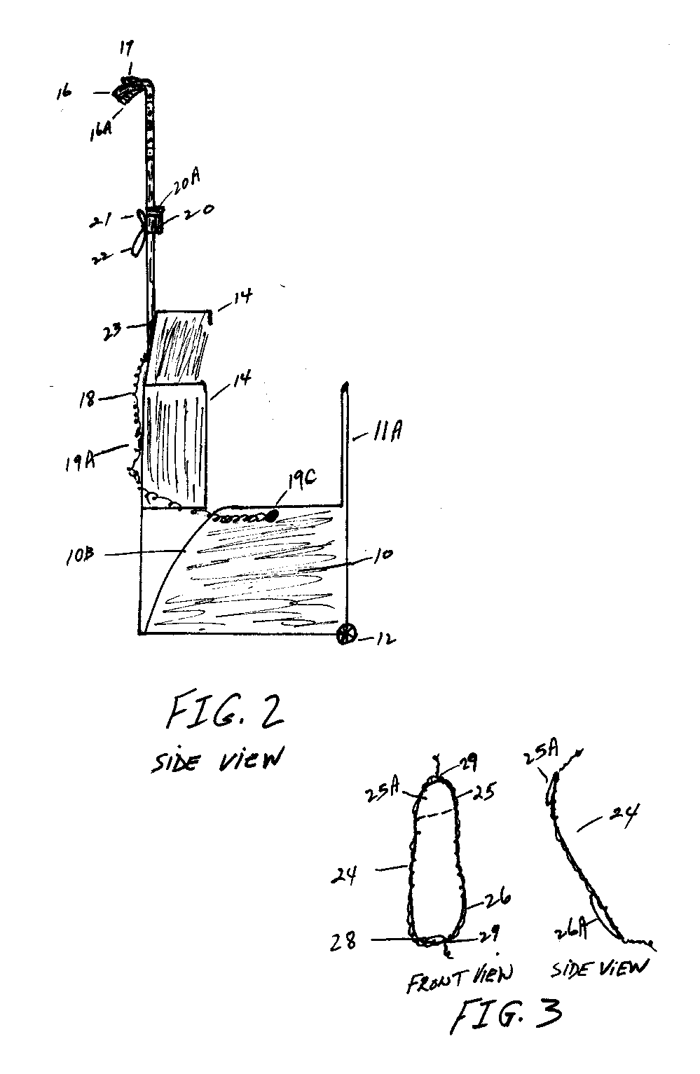

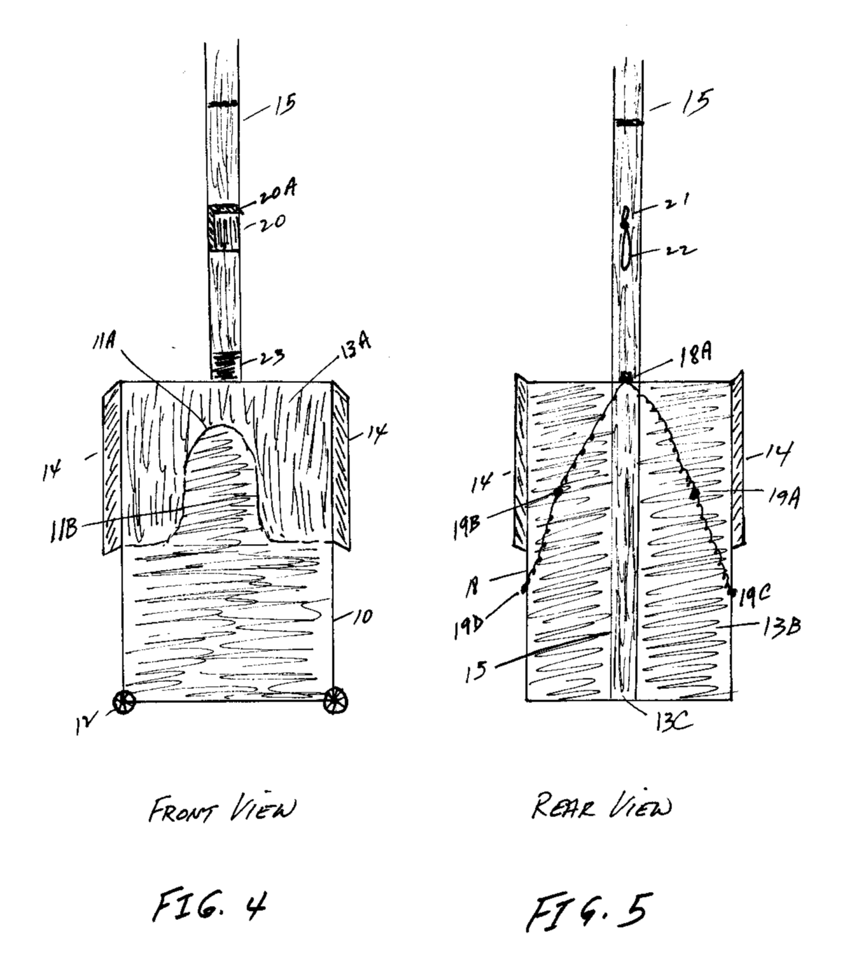

FIG. 1 is a view of the opened and extended Doggie Scoop when it is ready to be used. The Doggie Scoop has a storage compartment, a Storage Box, 10, into which the dog poop drops when the Scoop is closed. The Storage Box is rectangular in shape, with a width, depth, and height. It is wider from left to right than it is from front to back or from top to bottom. The shape of the Storage Box could also possibly be square or even circular or oval. Also, the Storage Box or compartment can be without sides.

The Front Portion of the Storage Box, 11, is attached to the Sides of the Box, 10A, and to the Base of the Box, 10C. The Top Rear Corners, 10B, of the Sides of the Storage Box that are near the Rear Section can be curved to give the Box a more smoother appearance and to allow water to drain out from the Box, if water gets into the Box, for example, on a rainy day.

The Front Portion of the Storage Box also extends outward to form the Extension, 11A. This Extension is shaped so that it can easily fit under a dog and between its legs. The Extension is elongated with grooves on the sides, 11B, to accommodate the dog's legs. The Extension could also be shaped without the grooves, but the grooves are more practical. The Extension should be made of material that is flat and smooth. The Extension can also be made of other textured material, but this will not be practical because, in the event of an emergency and the Doggie Scoop has to be used without a plastic bag, the dog poop will get stuck in the textured material and will be difficult to clean. When the Extension, 11A, is slid under the dog, it should lie flat against the ground to catch the poop. It is important for the Extension to lie flat against the ground because dogs usually squat close to the ground when they poop. When the Doggie Scoop is closed, the poop then drops into the Storage Box, 10.

Attached to the front corners of the Storage Box, 10, are a method of rotary transmission, Wheels, 12. These Wheels help in sliding the Extension, 11A, under a dog. The Wheels can rotate 360 degrees, thus enabling a person to move the Scoop in any direction to accommodate any movement of the dog, since dogs do move around when they poop. Also, dogs can possibly be trained to poop on the Scoop. The size of the Wheels should be in proportion to the Storage Box, 10, but should not be too large as the Extension, 11A, should be kept flat against the ground when the dog is pooping.

The Rear Section, 13, of the Storage Box is rectangular in shape, but could possibly be any other shape. It is longer from top to bottom than it is from left to right. In the middle of the top of the Rear Section is a device, a Hook, 23, where a plastic bag is attached. The Rear Section, 13, is connected to the Base of the Box, 10C, but disconnected from both sides, 10A, of the Box. The Connection, 13D, to the Base of the Box should be made of a flexible material enabling the Rear Section, 13, to be bent backward and forward without breaking. The Connection, 13D, can also be made of coil or spring or other similar material. The Doggie Scoop can be opened to extend completely horizontal and further, enabling a person, while standing, to easily position the Scoop under a dog; the person does not have to bend down to slide the Extension under the dog.

When the Doggie Scoop is closed, the Rear Section, 13, and the Extension, 11A, are in a vertical position. The Rear Section, 13, should be higher, vertically, than the Extension, 11A. This assures that when the Scoop is closed, dog poop will not fall outside of the Scoop.

Towards the upper portion of the Rear Section, 13, and attached to its sides are Side Flaps, 14. These Flaps are about one-third the width of the Storage Box, 10, and extend outward at a slight angle. The purpose of the Flaps, 14, is to catch any poop that might spatter when the Doggie Scoop is closed. The Side Flaps could possibly be wider, but this is not necessary and would only make the Doggie Scoop cumbersome. The length of the Side Flaps would extend from the top of the Rear Section downward to just above the Sides of the Storage Box, 10A, but without making contact. This is so that when the Doggie Scoop is closed, there is no interference between the two parts.

Attached to the Back of the Rear Section, 13B, and centered in the middle from left to right is the Collapsible Stem, 15. The Stem extends upward from the Base of the Rear Section, 13C, up to the Handle, 16. The Stem can collapse from the Handle, 16, down to the top of the Small Box, 20. Also, the entire length of the Stem could also possibly collapse. The Stem will collapse simply by pressing the Knob, 15A, at the top of the Stern, 15, and aligning it with the plurality of Adjustment Holes, 15B. A push-button device could also possibly be used to collapse the stem. The Stem is rectangular in shape, wider from left to right than it is from front to back. The corners of the Stem could be slightly curved to give it a more sleek appearance yet still be functional. The Stem could also possibly be round or oval or spiral or other shape. The Stem houses the mechanism for the Operating Device, the Handle, 16, and Lock, 17. It also houses the Connecting Cords, 18, from the Handle, 16, down to the Entrance for the Cords, 18A.

The Stem extends upwards, and at the top, is the Doggie Scoop's Operating Device, the Handle, 16, and Lock, 17. To operate and use the Doggie Scoop, grasp the Handle. The Handle is curved and would fit comfortable in a person's hand. The Lower Portion of the Handle, 16A, is moveable. At the top, front portion of the Handle is the Lock, 17. It is conveniently located so that a person can simply slide the Lock forward with his or her thumb to open the Doggie Scoop, and, after squeezing the Lower Portion of the Handle, 16A, slide the Lock backward with the thumb to lock the Scoop and keep it closed. The Operating Device could also possibly include push buttons instead of the lock. Push one button to open the Scoop, then push another button to close the Scoop. Sliding the Lock, 17, forward releases a mechanism inside the Handle, 16, or it can also be housed outside the Handle or Stem, wherein the Connecting Cords, 18, unwind and the Doggie Scoop can be opened to a horizontal position and further. Squeezing the Lower Portion of the Handle, 16A, rewinds the Connecting Cords and the Scoop closes.

The Connecting Cords, 18, are connected from the Handle, 16, down through the inside of the Stem, 15, to the Entrance to the Cords, 18A. Here they diverge, one Cord is connected to one side of the Rear Section, 19A, and the other cord to the other side of the Rear Section, 19B, then to one side of the Side of the Storage Box, 19C, and to the other side of the Storage Box, 19D. The Connecting Cords should be made of strong, thin, flexible, water- and weather-resistant and corrosion-free material, for example, nylon or stainless steel.

When the Lock, 17, on the Handle is slid forward to unlock the Doggie Scoop, it unwinds and loosens the Cords, 18, enabling the Scoop to be opened horizontally. When the Moveable Lower Portion of the Handle, 16A, is squeezed, it reverses the operation and rewinds the Cords and closes the Doggie Scoop. When the Lock on the Handle, 17, is slid backward, it locks the Scoop and keeps it closed.

Towards the middle of the rear of the Stem are two connected Loops, a stationary Finger Loop, 21, with the Loop positioned upward, and a larger, moveable Hand Loop, 22, positioned downward. The Doggie Scoop can be carried by a finger, with the Finger Loop, or by the hand or arm, with the Hand Loop. For example, the Doggie Scoop can be carried on the arm while a person is talking on a cell phone with one hand, while walking the dog on a leash with the other hand. The Loops should be made of soft, or comfortable to the hand, non-stretchable material. The Loops can also be just one Loop instead of two, or no loops at all.

Opposite the Loops on the front side of the Stem is a Small Box, 20, to store the Disposable Plastic Bags. The Plastic Bags can be wound into a roll of, for example, 25 bags, and the roll would be stored inside the Small Box. To remove a bag, one would simply pull it out from the center of the roll, one bag at a time. The Small Box could possibly fit inside the Stem, but that would interfere with the operation of the Connecting Cords. The Small Box would be rectangular in shape, longer from top to bottom than it is from front to back or left to right, with slightly curved edges to give it a sleek, but still functional look. The top of the Box would have a Cover, 20A. The Cover would be connected to the Box, but not locked so that one can easily flip the Cover open to retrieve the Plastic Bags. This top Cover would also prevent rain from entering the Box.

The Doggie Scoop is used with a Disposable Plastic Bag, 24, inserted in it. The Scoop can be used without the Plastic Bag, for example, in emergencies when a dog wants to poop again but you have just used your last plastic bag and there is no other plastic bag readily available. However, using the Scoop without a plastic bag inserted means that the dog poop will have to be removed and the Scoop washed; a messy and avoidable situation. Using the Disposable Plastic Bag, 24, will eliminate this situation and reduce the number of times the Scoop has to be cleaned. Though the Doggie Scoop does not have to be washed after every use since it would not be soiled, it should be washed every once in a while.

The Disposable Plastic Bag, 24, is made of, as the name implies, disposable and biodegradable plastic. The Bag is shaped to fit inside the Scoop, with the Front Part, 25, having a Top Flap, 25A, that fits over the front of the Extension, 11A, and the Rear Part of the Plastic Bag, 26, having Flaps, 26A, that fit over the Side Flaps, 14, of the Rear Section, 13, of the Storage Box. There is also a Center Opening, 28, in the Rear Part of the Plastic Bag that fits into the Hook, 23, attached to the Stem. Winding through the outer section of the Disposable Plastic Bag are the Pull Cords, 29, made of thin cotton cord or similar material. One would simple grasp the Pull Cords to remove the Plastic Bag with its contents from the Doggie Scoop. Removing the Plastic Bag in this manner will eliminate having to touch the dog poop. Additionally, when there is no garbage can readily available in which to dispose of the Bag and its contents, the poop can be left in the Plastic Bag in the Doggie Scoop until a garbage can is found.

The Doggie Scoop can be made in the different sizes of small, medium, and large to accommodate the different size dogs.

The Doggie Scoop should be made of material that is light-weight yet sturdy and durable, smooth material that is water- and weather-resistant and corrosion free.

The Doggie Scoop should also be made of material that can be produced in different colors and on which different logos and designs can be imprinted.

### CONCLUSION, RAMIFICATIONS, ETC.

Canine fecal matter (dog poop) left on the ground is unsightly, an inconvenience, a health hazard, it creates an unsanitary environment, and in many areas, is against the law and subjects a person to hefty fines. Though most people want to eliminate this situation and abide by the law, they do not have available to them the correct device to use in cleaning up after their pets. A review of the devices that are available and a review of the prior art indicates devices that are deficient in many aspects: some are impractical, others are poorly designed and inefficient, and still others are cumbersome and difficult to use.

Observing this situation, I developed the idea of the Doggie Scoop. With the Doggie Scoop, people will be able to pick up after their pets in an efficient and sanitary manner while at the same time abiding by the law. The Doggie Scoop is easy to use and efficient. It enables a person to collect and dispose of the dog poop without having to bend down to pick up the poop or to touch the poop with their hands in a plastic bag. The Doggie Scoop works in this manner: Before using the Doggie Scoop, insert a Disposable Plastic Bag into the Scoop (extra bags are kept in a small box on the stem of the Scoop). When a dog gets ready to poop, slide the Lock on the Handle of the Scoop forward with your thumb to open the Scoop, then slide the Extension of the Scoop under the dog to collect the poop. The Extension should lie flat against the ground since dogs usually squat close to the ground when they poop. The Wheels on the Scoop, which rotate 360 degrees, will enable a person to move the Scoop in any direction to accommodate any movement of the dog, as dogs do move around when they poop. After the dog is finished, slide the Scoop out from under the dog, squeeze the moveable portion of the Handle to close the Scoop, then, with your thumb, slide the Lock on the Handle of the Scoop backward to lock the Scoop and keep it closed. The poop that collected on the Extension drops into the Storage Box. Grasp the Pull Cords on the enclosed Disposable Plastic Bag to remove the Bag with its contents from the Scoop. Dispose of the Plastic Bag in a garbage can.

The Scoop is used while standing so that a person does not have to bend down to position the Scoop under the dog; the Scoop can be opened horizontally so that the Scoop can be easily positioned under the dog. The Scoop can used on rainy days or if a dog releases wet or messy poop, situations when picking up after a dog can be especially disgusting. Additionally, a dog can possibly be trained to poop on the Scoop. The Doggie Scoop is light-weight and easy to carry and is designed for efficient and sanitary use, making it easy for people to pick up after their pets and also abide by their civic duty.

The Doggie Scoop offers all the advantages with few, if any, disadvantage. The advantages include: A device that is easy to use, light-weight to carry, and functionally efficient; a device to collect and dispose of dog poop without having to bend down to pick up the poop and without having to touch the stuff; a device ergonomically designed for the efficient collecting of dog poop by a person and without discomfort or inconvenience to a dog. The only possible disadvantage I see would be getting the Plastic Bag to fit properly inside the Scoop. However, the Plastic Bag has a Front Flap that fits over the front of the Extension, and Side Flaps that fit over the Side Flaps of the Scoop, also a Center Opening that hooks on to the Rear Section of the Scoop.

Hopefully, the Doggie Scoop will solve most of the problems of dog poop left on the ground and people not having the correct device to use when picking up after their pets, because now people will have available to them the correct device to use—a device that is simple, well-designed, lightweight, practical, efficient and effective.

### DRAWINGS REFERENCE NUMBERS

10. Storage Box
10A. Sides of Storage Box
10B. Curved Corners of Storage Box
10C. Base of Storage Box
11. Front Portion of Storage Box
11A. Extension
11B. Grooves in Extension
12. Wheels
13. Rear Section of Storage Box
13A. Front of Rear Section
13B. Back of Rear Section
13C. Base of Rear Section
13D. Flexible Connection to Base of Storage Box
14. Side Flaps Angled Slightly Outward
15. Collapsible Stem
15A. Adjustment Knob
15B. Adjustment Holes
16. Handle
16A. Moveable Lower Portion of Handle
17. Lock
18. Connecting Cords
18A. Entrance for Connecting Cords
19A. Connection to Right of Rear Section
19B. Connection to Left of Rear Section
19C. Connection to Right Side of Storage Box
19D. Connection to Left Side of Storage Box
20. Small Box for Plastic Bags
20A. Cover of Small Box
21. Stationary Finger Loop
22. Moveable Hand Loop
23. Hook for Plastic Bag
24. Disposable Plastic Bag
25. Front Section of Disposable Plastic Bag
25A. Top Flap of Disposable Plastic Bag
26. Rear Section of Disposable Plastic Bag
26A. Side Flaps of Disposable Plastic Bag
28. Center Opening in Disposable Plastic Bag
29. Pull Cords of Disposable Plastic Bag

I claim:

1. A device or apparatus for the collection and disposal of canine fecal matter (dog poop) comprising: operating mechanisms, collecting receptacles and storage commpartments, wherein said device allows for the sanitary and efficient collection and disposal of dog poop.

2. The dog poop collection device of claim 1 comprising a receptacle or storage box wherein said storage box is rectangular in shape, wider from left to right than from front to back or top to bottom, and with a base, two sides with curved top rear corners, a front section with an elongated extension, a rear section and rotary devices, wheels, connected to the front corners of said storage box and said wheels rotate 360 degrees.

3. The storage box of claim 2 wherein said base section is connected to said sides and said front section, and said rear section is disconnected from and there is no contact with said sides of said box, but is connected to said base of said box by a flexible material. Said disconnection allows for water drainage from said box.

4. The storage box of claim 2 wherein attached to the front corners of said storage box are rotary transmission devices, wheels, that rotate 360 degrees. Said rotary devices being in proportion to said storage box but still enabling said extension of said storage box to lie flat against the ground when said dog poop collection device is in use.

5. The dog poop collection device of claim 1 comprising an extension of said front section of said storage box.

6. The dog poop collection device of claim 5 wherein said extension of said storage box is elongated in shape, and with curved front portion and grooves along both sides of said extension to allow said extension to fit comfortably under a dog and between its legs.

7. The dog poop collection device of claim 1 wherein said rear section of said storage box is rectangular in shape, longer from top to bottom than from left to right, and extending from the base of said storage box upwards, and said rear section is disconnected from said sides of said storage box but connected to said base of said storage box by a flexible material, or coil or spring, or other similar device, allowing said rear section to be bent backward and forward without breaking.

8. The dog poop collection device of claim 7 wherein attached to the sides of said rear section at a slight outward angle, are side flaps about one-third the width of said sides of said storage box, and extending from the top of said rear section downward to the top of said sides of the closed said storage box but without making contact.

9. The dog poop collection device of claim 7 wherein attached to the top of said rear section and centered in the middle is an element, a hook, for securing a disposable plastic bag.

10. The dog poop collection device of claim 1 wherein a collapsible stem or pole is attached to the base of said rear section and extends upward.

11. The dog poop collection device of claim 10 wherein said stem is collapsible with an adjustment knob and a plurality of adjustment holes.

12. The dog poop collection device of claim 1 comprising of the operating device, a handle and a closing mechanism, a lock.

13. The dog poop collection device of claim 12 wherein said handle is curved to fit a person's hand comfortably, and has a moveable lower portion wherein when said portion is squeezed, said dog poop collection device is closed.

14. The dog poop collection device of claim 12 wherein attached to the top of the front portion of said handle is a locking mechanism, a lock, that can be moved forward and backward, and said lock opens said dog poop collection device and locks and keeps said device closed.

15. The dog poop collection device of claim 12 wherein inside said handle or said stem the connecting cords are attached and attached to a mechanism wherein said cords are wound and unwound. Said cords are also connected through the inside of said stem for the length of said stem and said cords are also connected to the sides of said rear section and the sides of said storage box.

16. The dog poop collection device of claim 1 wherein attached to the front of said stem is a container for the storage of disposable bags. Said container is rectangular in shape, longer from top to bottom that from left to right or from front to back, with slightly curved edges to give it a sleek appearance yet still functional, and with an unlocked flip cover. Plastic bags wound into rolls would be stored inside said container and can be retrieved, one bag at a time, from the center of the roll.

17. The dog poop collection device of claim 1 wherein attached to the rear section of said stem and opposite said small box are two connected carrying devices, loops. Of said loops, one is a stationery finger loop positioned upward, and the other is a moveable hand loop, positioned downward. Said loops should be made of smooth, durable, non-stretchable material.

18. The dog poop collection device of claim 1 wherein the elements of said device are made of material that is smooth, durable, water- and weather-resistant and corrosion free.

19. A disposable plastic bag comprising: a front section with a top flap, a rear section with side flaps, said flaps fit over the extension and the side flaps of said dog poop collection device, and intertwined throughout the outer edges of said disposable plastic bag are pull cords for retrieving said disposable plastic bag from said dog poop collection device; wherein said disposable plastic bag enables a person to collect and dispose of dog poop in a sanitary manner without having to touch the poop.

20. A method of operating a dog poop collection device comprising:
a. inserting a disposable plastic bag into said dog poop collection device,
b. sliding the lock on the handle of said dog poop collection device forward to open said device; said device opens horizontally,
c. sliding the extension of said device under a dog as it is about to poop, keeping said extension flat against the ground; the rotary transmission devices, the wheels, attached to the front section of said device allow for moving said device in any direction to accommodate any movement of the dog,
d. sliding said device out from under the dog when it finishes,
e. squeezing the moveable portion of the handle of said dog poop collection device to close the device,
f. moving the lock backward on the handle of said dog poop collection device to lock said device and keep said device closed,
g. grasping the pull cords on said enclosed disposable plastic bag to remove the bag with its contents,
h. disposing of the removed said disposable plastic bag in a garbage can.
